(19) United States
(12) Patent Application Publication
(10) Pub. No.: US 2003/0200132 A1
(43) Pub. Date: Oct. 23, 2003

(54) Automatic marketing of networking solution

(75) Inventor: Nathan H. Bryant, American Fork, UT (US)

Correspondence Address: GATEWAY, INC., 14303 GATEWAY PLACE, ATTENTION: MARK WALKER (MAIL DROP SD-21), POWAY, CA, 92064, US

(73) Assignee: Gateway, Inc.

(21) Appl. No.: 10/128,385

(22) Filed: Apr. 23, 2002

(51) Int. Cl. G06F 17/60

(52) U.S. Cl. 705/10

(57) ABSTRACT

A method, apparatus, and signal-bearing medium for recommending to a potential customer that the customer retain a current electronic device and purchase additional products to use the current electronic device in a network. The recommendation may be made based on the electronic device's configuration.

### FIELD

This invention relates generally to electronic devices and more particularly to marketing a networking solution based on a configuration of an electronic device.

### BACKGROUND

The Internet has seen dramatic growth in only a few years with many homes having personal computers connected to the Internet. But, now networks are spreading to inside the home, and home appliances, such as television sets, VCRs (Video Cassette Recorders), stereos, telephones, and computers are beginning to be connected to each other. These appliances, and many others, may be connected via existing telephone lines, AC (Alternating Current) power wiring, and wireless communications.

The computer and semiconductor industries have recognized the potential for connecting home appliances, and have created the Home Phone Line Networking Alliance (HPNA) to select, promote, and standardize technologies for home phone line networking. But, in order to enjoy the benefit of interconnected home appliances, consumers need to have the appropriate hardware and software to take advantage of this new technology. Further, in order to sell more products, providers of networking products need to effectively communicate to their customers how the new technology can fit with the customers' existing appliances. Without appropriate information about networking, consumers will be hampered in their ability to enjoy the benefits of this new technology, and providers will be hampered in their ability to sell their products.

### SUMMARY

The invention provides a method, apparatus, and signal-bearing medium for recommending to a potential customer that the customer retain a currently-owned electronic device and purchase additional products for use with the electronic device in a network. A recommendation may be made to upgrade the electronic device based on an analysis of the configuration of the electronic device, so that the electronic device is capable of operating in a network.

### BRIEF DESCRIPTION OF THE DRAWINGS

FIG. 1 depicts a block diagram of a network for implementing an embodiment of the invention.

FIG. 2 depicts a block diagram of configuration data, according to an embodiment of the invention.

FIG. 3 depicts a block diagram of a configuration rules, according to an embodiment of the invention.

FIG. 4 depicts a flowchart of processing, according to an embodiment of the invention.

### DETAILED DESCRIPTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

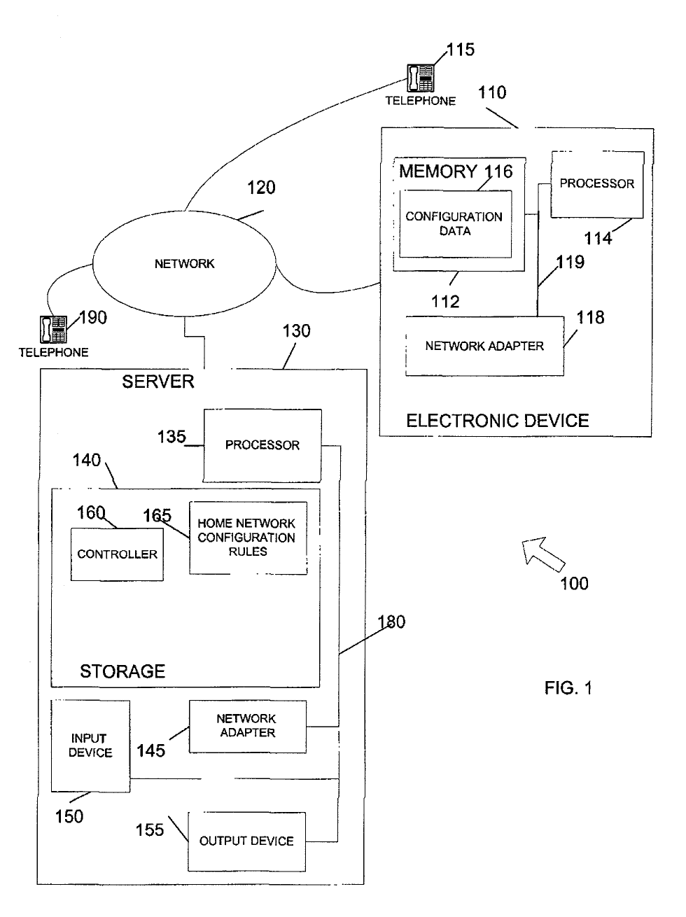

FIG. 1 depicts a block diagram of a network of electronic devices for implementing an embodiment of the invention.

System 100 may include electronic device 110, telephone 115, network 120, server 130, and telephone 190. According to this embodiment, server 130 may analyze the configuration of electronic device 110 and may make networking recommendations to electronic device 110 based on the configuration.

Electronic device 110 may be implemented using any suitable hardware and/or software, such as a personal computer available from a number of vendors. But, other embodiments may be portable computers, network computers, laptop or notebook computers, PDAs (Personal Digital Assistants), mainframe computers, cellular phones, pocket computers, pagers, or any other suitable computing devices. Although one electronic device 110 is shown, in other embodiments any number of electronic devices may be present.

Electronic device 110 may include memory 112, processor 114, and network adapter 118, all connected via bus 119. In another embodiment, electronic device 110 may also include an unillustrated input device and/or an output device

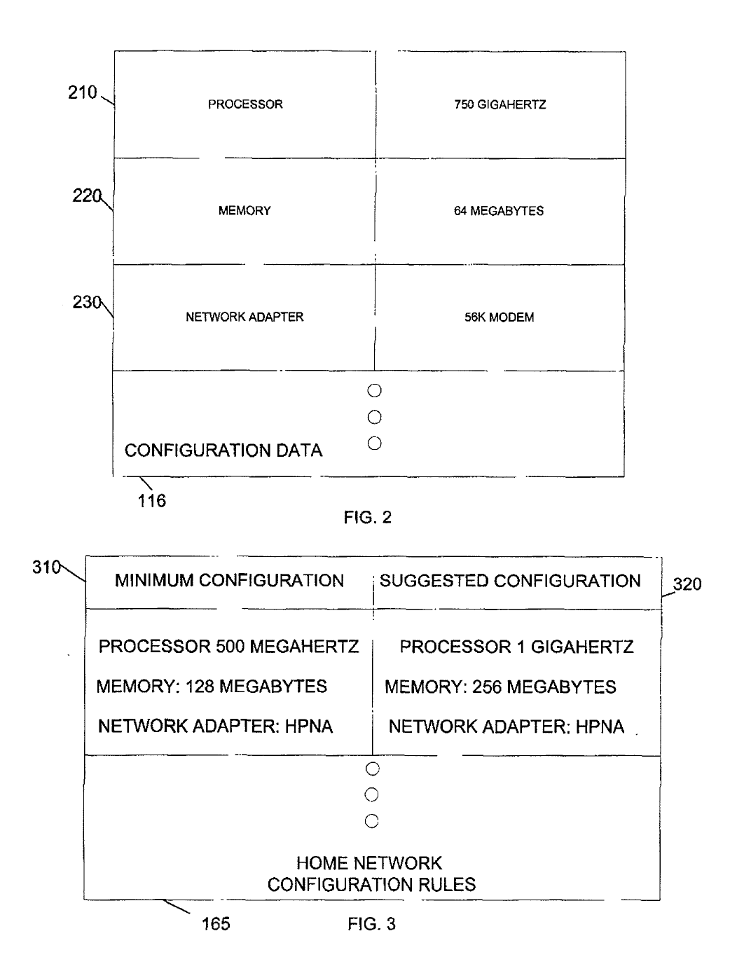

Memory 112 may contain configuration data 116, which may describe the configuration of electronic device 110. In an embodiment, configuration data 116 may include the speed of processor 114, the size of memory 112, an indication of the presence or absence of network adapter 118, and the characteristics of network adapter 118. In another embodiment, configuration data 116 may include more or fewer items. Configuration data 116 is further described below with reference to FIG. 2. Referring again to FIG. 1, although only one memory 112 is shown, in another embodiment, multiple memories and/or multiple levels of memory may be present.

Processor 114 may represent a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 114 executes instructions and includes that portion of electronic device 110 that controls the operation of the entire electronic device. Although not depicted in FIG. 1, processor 114 typically includes a control unit that organizes data and program storage in memory and transfers data and other information between the various parts of electronic device 110. Processor 114 may read and store code and data from/to memory 112. Processor 114 also may transmit and receive information across network 120 using network adapter 118. In another embodiment, logic circuits may be substituted for processor 114.

Telephone 115 may be any form of telephone, including hard-wired and wireless telephones. Telephone 115 may be connected to network 120. Telephone 115 may be utilized by a user of electronic device 110. In another embodiment, telephone 115 may not be present.

Network adapter 118 may facilitate communication between electronic device 110 and network 120. Network adapter 118 may provide electronic device 110 with a means of electronically communicating information with a remote electronic device, such as server 130. In addition, in another embodiment, network adapter 118 may support distributed processing, which enables electronic device 110 to share a task with other devices linked to network 120. Although network adapter 118 is shown as part of electronic device 110, in another embodiment they may be packaged separately. Although only one network adapter 118 is shown, in other embodiments multiple network adapters of the same or of a variety of types may be present. In an embodiment, network adapter 118 may support the HPNA (Home Phone Line Networking Alliance) protocol.

Bus 119 may represent one or more busses (e.g., PCI, ISA (Industry Standard Architecture), X-Bus, EISA (Extended Industry Standard Architecture), or any other appropriate bus and/or bridge (also called a bus controller).

Network 120 may be any suitable network capable of supporting communication between electronic device 110, telephone 115, server 130, and telephone 190. Although one network 120 is shown, in other embodiments any number of networks and/or combinations of networks may be present. In an embodiment, network 120 may support wireless communications. In another embodiment, network 120 may support hard-wired communications, such as a telephone line or cable. In an embodiment network, 120 may be the Internet and supports IP (Internet Protocol). In other embodiments, network 120 may be a local area network (LAN) or a wide area network (WAN). In another embodiment, network 120 may support a HPNA (Home Phone Line Networking Alliance) protocol. In an embodiment, telephones 115 and 190 may use the same network as electronic device 110 and server 130, but in another embodiment, they may use different networks. In still other embodiments, network 120 may support any appropriate protocol or protocols.

Server 130 may include processor 135, storage device 140, network adapter 145, input device 150, and output device 155, all communicatively coupled via bus 180. Processor 135 may represent a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 135 executes instructions and includes that portion of server 130 that controls the operation of the entire server. Although not depicted in FIG. 1, processor 135 typically includes a control unit that organizes data and program storage in computer memory and transfers data and other information between the various parts of server 130. Processor 135 may receive input data from input device 150 and network adapter 145, read and store code and data in storage device 140, and may present output data to a sales representative via output device 155. Processor 135 also may transmit and receive packets of information across network 120 using network adapter 145.

Although server 130 is shown to contain only a single processor and a single bus, the present invention applies equally to servers that may have multiple processors and to servers that may have multiple buses with some or all performing different functions in different ways.

Storage device 140 represents one or more mechanisms for storing data. For example, storage device 140 may include read only memory (ROM), random access memory (RAM), magnetic disk storage media, optical storage media, flash memory devices, and/or other machine-readable media. Although only one storage device 140 is shown, multiple storage devices and multiple types of storage devices may be present. Further, although server 130 is drawn to contain storage device 140, it may be distributed across other servers.

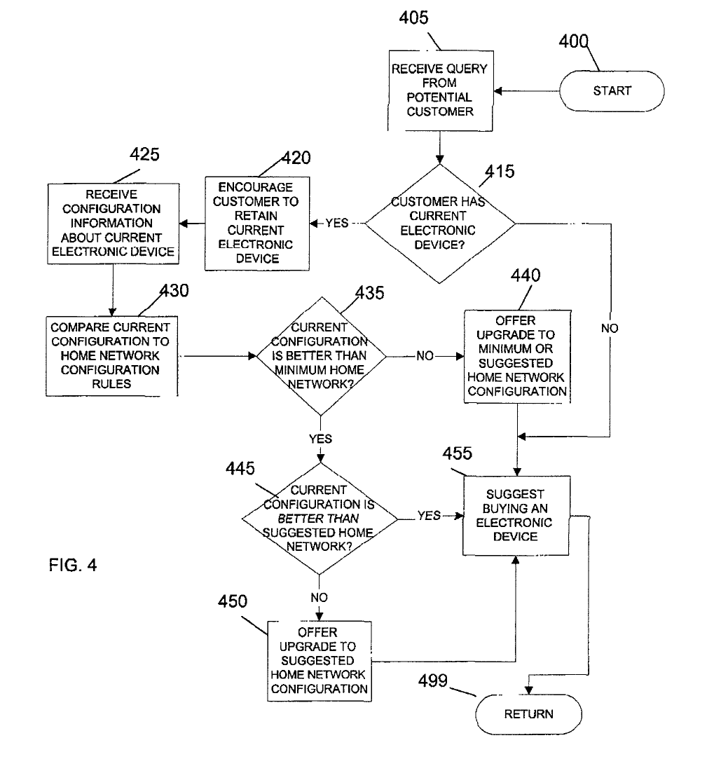

Storage device 140 may include controller 160 and home network configuration rules 165. Controller 160 may include instructions capable of being executed on processor 135 to carry out the functions of the present invention, as further described below with reference to FIG. 4. In another embodiment, some or all of the functions of the present invention may be carried out via hardware in lieu of a processor-based system. Of course, storage device 140 may also contain additional software and data (not shown), which is not necessary to understanding the invention.

Home network configuration rules 165 may include a minimum and a suggested configuration for an electronic device to be able to support a home network. Home network configuration rules 165 is further described below with reference to FIG. 3.

Bus 180 may represent one or more busses (e.g., PCI, ISA (Industry Standard Architecture), X-Bus, EISA (Extended Industry Standard Architecture), or any other appropriate bus and/or bridge (also called a bus controller).

Network adapter 145 facilitates communication between server 130 and network 120. Network adapter 145 provides server 130 with a means of electronically communicating information with a remote electronic device, such as electronic device 110. In addition, in another embodiment, network adapter 145 may support distributed processing, which enables server 130 to share a task with other devices linked to network 120. Although network adapter 145 is shown as part of server 130, in another embodiment they may be packaged separately. Although only one network adapter 145 is shown, in other embodiments multiple network adapters of the same or of a variety of types may be present.

Input device 150 is that part of server 130 that accepts input from a user, who in an embodiment may be a sales representative. In an embodiment, input device 150 may be a keyboard, but in other embodiments, input device 150 may be a pointing device, mouse, trackball, keypad, touchpad, touch screen, pointing stick, microphone, or any other appropriate input device. Although only one input device 150 is shown, in other embodiments any number of input devices of the same or of a variety of types may be present. In another embodiment, input device 150 may not be present.

Output device 155 communicates information to the user of server 130. Output device 155 may be a cathode-ray tube (CRT) based video display well known in the art of computer hardware. But, in other embodiments output device 155 may be replaced with a liquid crystal display (LCD) based or gas, plasma-based, flat-panel display. In still other embodiments, any appropriate display device may be used. In yet other embodiments, a speaker that produces audio output may be used. Although only one output device 155 is shown, in other embodiments, any number of output devices of different types or of the same type may be present. In other embodiments, output device 155 might not be present.

Server 130 may be implemented using any suitable hardware and/or software, such as a personal computer or other electronic computing device. Portable computers, laptop or notebook computers, and mainframe computers are examples of other possible configurations of server 130. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted. Thus, an embodiment of the invention may apply to any hardware configuration that supports analyzing an electronic device configuration.

Telephone 190 may be any type of telephone, analogous to telephone 115. In another embodiment, telephone 190 may not be present.

As will be described in detail below, aspects of an embodiment pertain to specific apparatus and method elements implementable on servers. In another embodiment, the invention may be implemented as a program product for use with a server. The programs defining the functions of this embodiment may be delivered to a server via a variety of signal-bearing media, which include, but are not limited to:

(1) information permanently stored on a non-rewriteable storage medium (e.g., read-only memory devices attached to or within a server, such as a CD-ROM readable by a CD-ROM drive);

(2) alterable information stored on a rewriteable storage medium (e.g., a hard disk drive or diskette); or

(3) information conveyed to a server by a communications medium, such as through a computer or telephone network accessed via network adapter 145, including wireless communications.

Such signal-bearing media, when carrying processor-readable instructions that direct the functions of the present invention, represent embodiments of the present invention.

FIG. 2 depicts a block diagram of configuration data 116, according to an embodiment of the invention. Configuration data 116 represents the current configuration of electronic device 110. Configuration data 116 includes processor field 210, memory field 220, and network adapter field 230. The fields shown in configuration data 116 are examples only, and more or fewer fields may be present. In the example shown, processor field 210 contains “750 gigahertz,” indicating the speed of processor 114; memory field 220 contains “64 megabytes,” indicating the size of memory 112; and network adapter field 230 contains “56K modem,” indicating the type of network adapter 118. But, the values illustrated in configuration data 116 are only examples, and any appropriate values may be present.

FIG. 3 depicts a block diagram of configuration rules 165, according to an embodiment of the invention. Configuration rules 165 indicate the minimum configuration 310 and the suggested configuration 320 needed for electronic device 110 to use home networking functions. Both minimum configuration 310 and suggested configuration 320 are suitable configurations for networking. In the example shown in FIG. 3, minimum configuration 310 indicates a processor speed of 500 megahertz, a memory size of 128 megabytes, and a network adapter type of HPNA. The suggested configuration 320 indicates a processor speed of 1 gigahertz, a memory size of 256 megabytes, and a network adapter type of HPNA. But, the values illustrated in configuration rules 165 are only examples, and any appropriate values may be present.

FIG. 4 depicts a flowchart of processing, according to an embodiment of the invention. Control begins at block 400. Control then continues to block 405 where controller 160 receives a query or request from a potential customer. In an embodiment, the query arrives via telephone 190. In another embodiment, the query arrives via network adapter 145. In an embodiment, the query may include a request for information. In another embodiment, the query may include an order for an electronic device.

Control then continues to block 415 where controller 160 determines whether the customer currently has an electronic device. In an embodiment, controller 160 may determine the customer has a current electronic device by virtue of receiving the query from the customer via network adapter 145 and/or examining configuration data 116. In another embodiment, controller 160 may determine whether the customer has a current electronic device by information communicated via telephone 190, which a sales representative then inputs to controller 160 via input device 150.

If the determination at block 415 is true, then the customer has a current electronic device, so control continues to block 420 where the customer is encouraged to retain the current electronic device to act as a part of home network. In another embodiment, the customer is encourage to retain the current device to act as part of a LAN (Local Area Network). In an embodiment, controller 160 encourages the customer to retain current electronic device 110 by transmitting advice via network adapter 145 and network 120 to electronic device 110. In another embodiment, controller 160 may encourage the customer to retain current electronic device 110 by displaying advice on output device 155, which the sales representative communicates to the customer via telephone 190.

Control then continues to block 425 where controller 160 receives configuration data 116 via network adapter 145. Control then continues to block 430 where controller 160 compares information within configuration data 116 to home network configuration rules 165. In an embodiment, controller may compare the processor speed, memory size, and network adapter type in configuration rules 165 to the corresponding fields in configuration data 116. But, in another embodiment any appropriate fields, including more or fewer fields may be compared.

Control then continues to block 435 where controller 160 determines whether the current configuration as indicated in configuration data 116 is better than minimum configuration 310 indicated in configuration rules 165. In an embodiment, the current configuration is better than the minimum configuration when the current configuration has a faster processor, more memory, and at least the correct network adapter to support home networking. But, in another embodiment, any appropriate criteria may be used to determine if the current configuration is better than the minimum configuration.

If the determination at block 435 is true, then control continues to block 445 where controller 160 determines whether the current configuration is better than the suggested home network configuration. In an embodiment, the current configuration is better than the suggested configuration when the current configuration has a faster processor, more memory, and at least the correct network adapter to support home networking. But, in another embodiment, any appropriate criteria may be used to determine if the current configuration is better than the suggested configuration.

If the determination at block 445 is true, then control continues to block 455 where controller 160 suggests buying an additional electronic device to add to the home network. In an embodiment controller 160 displays the suggestion to the sales representative on output device 155, and the sales representative relays the suggestion to the customer via telephone 190. In another embodiment, controller 160 sends the suggestion to the customer via network adapter 145. Control then continues to block 499 where the logic returns.

If the determination at block 445 is false, then control continues to block 450 where controller 160 offers to sell to the customer an upgrade from the current configuration to the suggested configuration. In an embodiment controller 160 displays the offer to the sales representative on output device 155, and the sales representative relays the offer to the customer via telephone 190. In another embodiment, controller 160 sends the offer to the customer via network adapter 145. Control then continues to block 455 as previously described above.

If the determination at block 435 is false, then control continues to block 440 where controller 160 offers to sell to the customer an upgrade from the current configuration to the minimum or the suggested configuration. In an embodiment controller 160 displays the offer to the sales representative on output device 155, and the sales representative relays the offer to the customer via telephone 190. In another embodiment, controller 160 sends the offer to the customer via network adapter 145. Control then continues to block 455 as previously described above.

If the determination at block 415 is false, then control continues to block 455 as previously described above.

In this way, a customer is encouraged to retain a current electronic device to participate in a home network. In an embodiment the current electronic device may become a server in the home network. But in other embodiments, the current electronic device may become client or peer on the home network. The server and/or sales representative encourages the customer to purchase a package (including the necessary hardware, software, service, and/or training) in order to use the current electronic device in a home network, which expands the capabilities of the new system being purchased. This eliminates the shipping and disposal of the current electronic device, increases revenue for the provider, and gives increased function to the customer.

Although the invention has been described in the context of a home network, the invention applies equally to a business network or other types of networks.

What is claimed is:

1. A computer-implemented method, comprising:
determining a current configuration of an electronic device;
comparing the current configuration to a minimum configuration for networking; and
when the configuration is less than the minimum configuration, recommending upgrading the electronic device from the current configuration to the minimum configuration.

2. The method of claim 1, further comprising:
when the current configuration is greater than the minimum configuration, but less than a suggested configuration for networking, recommending upgrading the electronic device from the current configuration to the suggested configuration.

3. The method of claim 1, wherein the current configuration further comprises a processor speed of the electronic device.

4. The method of claim 3, wherein comparing the current configuration to a minimum configuration for networking further comprises:
comparing the processor speed in the current configuration to a processor speed in the minimum configuration.

5. The method of claim 1, wherein the current configuration further comprises a memory size of the electronic device.

6. The method of claim 5, wherein comparing the current configuration to a minimum configuration for networking further comprises:
comparing the memory size in the current configuration to a memory size in the minimum configuration.

7. The method of claim 1, wherein the current configuration further comprises an indication of a type of network adapter in the electronic device.

8. The method of claim 7, further comprising:
comparing the indication in the current configuration to a network adapter needed for the minimum configuration.

9. A signal-bearing medium comprising instructions, wherein the instructions when read and executed by a processor comprise:
receiving a request from a potential customer wherein the potential customer has a current electronic device; and
in response to the request, recommending upgrading the current electronic device to a configuration suitable for networking.

10. The signal-bearing medium of claim 9, wherein configuration suitable for networking comprises a minimum configuration suitable for networking.

11. The signal-bearing medium of claim 9, wherein the configuration suitable for networking comprises a suggested configuration suitable for networking.

12. The signal-bearing medium of claim 9, wherein the request comprises a request for information.

13. The signal-bearing medium of claim 9, wherein the request comprises an order for a new electronic device, and wherein the recommending further comprises recommending using the current electronic device and the new electronic device in a network.

14. The signal-bearing medium of claim 9, wherein the recommending further comprises determining that a configuration of the current electronic device is less than a minimum configuration for networking.

15. A server comprising:
memory comprising configuration rules; and
a controller to:
receive a request from a potential customer wherein the potential customer has a current electronic device,
compare a current configuration of the current electronic device to the configuration rules, and
when the current configuration does not meet the configuration rules, recommend upgrading the electronic device to a networking configuration.

16. The server of claim 15, wherein the configuration rules further comprise a minimum configuration suitable for networking.

17. The server of claim 15, wherein the configuration rules further comprise a suggested configuration suitable for networking.

18. The server of claim 15, wherein the server further comprises a network adapter and wherein the request is received across a network via the network adapter.

19. The server of claim 15, wherein the server further comprises an input device and wherein the request is received by the controller via the input device.

20. The server of claim 15, wherein the configuration rules further comprise a processor speed, a memory size, and a network adapter characteristic.
